(19) United States
(12) Patent Application Publication
(10) Pub. No.: US 2016/0050457 A1
(43) Pub. Date: Feb. 18, 2016

(54) METHOD AND SYSTEM FOR TV CHANNEL CONTENT MANAGEMENT AND MONETIZATION BASED ON CONTENT FINGERPRINTING USING A PORTABLE COMPUTING AND COMMUNICATIONS DEVICE

(71) Applicants: SANDIPAN MONDAL, MIDDLETON, WI (US); SAJO MATHEWS, GURGAON (IN); DEEPAK BAID, GURGAON (IN)

(72) Inventors: SANDIPAN MONDAL, MIDDLETON, WI (US); SAJO MATHEWS, GURGAON (IN); DEEPAK BAID, GURGAON (IN)

(21) Appl. No.: 14/826,546

(22) Filed: Aug. 14, 2015

Related U.S. Application Data
(60) Provisional application No. 62/037,193, filed on Aug. 14, 2014.

(51) Int. Cl. H04N 21/442

(52) U.S. Cl. CPC H04N 21/44204

(57) ABSTRACT

Embodiments of the present invention disclose a method for media content management and monetization, and corresponding system therefor. The method comprises automatically and autonomously capturing audio contents at least one of periodically, adaptively, dynamically, randomly, customizably, and via a combination thereof, from programs displayed and viewed on TV channels by users using portable computing and communications devices, automatically and autonomously generating corresponding audio fingerprints of the captured audio contents using the portable computing and communications devices for transmission to at least one of an external cloud-based host server comprising a cloud-based database, automatically and autonomously capturing audio contents continuously from all the programs available for display on the TV channels using an in-house data processor comprising at least one of an in-house processing host server and a Set-Top Box (STB), automatically and autonomously generating corresponding audio fingerprints of the captured audio contents from all the programs available for display on the TV channels using the in-house data processor comprising the in-house processing host server and Set-Top Box (STB) for transmission to the external cloud-based host server comprising the cloud-based database, automatically and autonomously comparing the audio fingerprints generated by the portable computing and communications devices versus the audio fingerprints generated by the in-house data processor comprising the in-house processing host server and Set-Top Box (STB), using the external cloud-based host server comprising the cloud-based database, automatically and autonomously determining which one or more of the users is watching which one or more of the programs on which one or more of the TV channels based on the results of the comparison, automatically and autonomously sending the matched results of the comparison for the determined users to the cloud-based database of the external cloud-based host server for storage and further processing, automatically and autonomously generating a comprehensive viewership profile information for the determined users and utilizing the comprehensive viewership profile for one or more content monetization opportunities.

### CROSS-REFERENCE TO RELATED APPLICATIONS

This application claims benefit of the U.S. Provisional Patent Application No. 62/037,193 filed Aug. 14, 2014, which is incorporated herein by reference in its entirety.

### BACKGROUND OF THE INVENTION

1. Field of the Invention

Embodiments of the present invention generally relate to content management comprising Automatic Content Recognition (ACR), content fingerprinting, user profile generation and monetization of the same via usage of portable computing and communications devices, and more particularly, to ACR based on automatic acoustic (or audio) fingerprint generation and comparison, thereby facilitating comprehensive TV viewership profiling of the users viewing the TV contents and monetization of the same using the portable computing and communications devices and processing severs.

2. Description of the Related Art

Nowadays, people get the same TV content from different vendors through different communication channels, such as satellite, cable, phone line, and Internet. However, the choice of communication channels often has many geographic and demographic considerations. For example, satellite receivers may be the most commonly used devices for households in the rural areas to receive TV signals. But, households in big metropolitan areas may probably more commonly prefer using cable connections or Over-the-Air (OTA) antennas to receive TV signals. Although many people still watch TV programs on TVs, young viewers may increasingly choose to watch TV programs on a computer connected to the Internet, or even a smartphone supporting 3G/4G wireless connections. The issues with the existence of diversified communication channels for receiving TV programs is it is more challenging to provide an efficient, accurate estimate of the viewership rating for a particular TV program at a large population level.

Smart or connected TVs may receive data from networks, such as Internet networks, that allow a viewer to not only access broadcast digital content, but also receive multimedia content. In addition viewers without Smart TVs can access additional content via a smartphone or tablet or phablets. With the proliferation of connected TVs and wireless communication devices, such as smartphones, tablets and phablets, content or network providers now have a plethora of avenues for distributing media including programming, advertisements and interactive content.

Further limitations and disadvantages of conventional and traditional approaches will become apparent to one of skill in the art, through comparison of such systems with the present invention as set forth in the remainder of the present application with reference to the drawings.

Specifically, there is still a need for the design and implementation of methods, apparatuses and systems for ACR based on fully automatic, i.e. no manual or user intervention, acoustic (or audio) fingerprint generation and comparison, thereby facilitating comprehensive viewership profiling of the users viewing the TV contents and monetization of the same using the portable computing and communications devices.

More specifically, there is still a need for the design and implementation of methods, apparatuses and systems facilitating real-time second screen engagement with or without manual intervention.

### SUMMARY OF THE INVENTION

Embodiments of the present invention disclose a method for media content management and monetization, and corresponding system therefor. The method comprises automatically and autonomously capturing audio contents at least one of periodically, adaptively, dynamically, randomly, customizably, and via a combination thereof, from programs displayed and viewed on TV channels by users using portable computing and communications devices, automatically and autonomously generating corresponding audio fingerprints of the captured audio contents using the portable computing and communications devices for transmission to at least one of an external cloud-based host server comprising a cloud-based database, automatically and autonomously capturing audio contents continuously from all the programs available for display on the TV channels using an in-house data processor comprising at least one of an in-house processing host server and a Set-Top Box (STB), automatically and autonomously generating corresponding audio fingerprints of the captured audio contents from all the programs available for display on the TV channels using the in-house data processor comprising the in-house processing host server and Set-Top Box (STB) for transmission to the external cloud-based host server comprising the cloud-based database, automatically and autonomously comparing the audio fingerprints generated by the portable computing and communications devices versus the audio fingerprints generated by the in-house data processor comprising the in-house processing host server and Set-Top Box (STB), using the external cloud-based host server comprising the cloud-based database, automatically and autonomously determining which one or more of the users is watching which one or more of the programs on which one or more of the TV channels based on the results of the comparison, automatically and autonomously sending the matched results of the comparison for the determined users to the cloud-based database of the external cloud-based host server for storage and further processing, automatically and autonomously generating a comprehensive viewership profile information for the determined users and utilizing the comprehensive viewership profile for one or more content monetization opportunities.

A system for media content management and monetization. The system comprises a client subsystem comprises one or more portable computing and communications devices. Each of the portable computing and communications devices comprises a first microcomputer unit. The first microcomputer unit comprises a first Input/Output (I/O) subunit coupled to at least one of a first acoustic transducer and sensor facilitating automatically and autonomously capturing audio contents at least one of periodically, adaptively, dynamically, randomly, customizably, and via a combination thereof, from programs displayed and viewed on TV channels by users. The first microcomputer unit comprises a first memory subunit. The first memory unit comprises a client-side proprietary mobile application software. The client-side proprietary mobile application software comprises an acoustic/audio fingerprint generator facilitating automatically and autonomously generating corresponding audio fingerprints of the captured audio contents using the portable computing and communications devices. In addition, the system comprises a server subsystem. The server subsystem comprises an in-house data processor. The in-house data processor comprises at least one of a second acoustic transducer and sensor facilitating automatically and autonomously capturing audio contents continuously from all the programs available for display on the TV channels. The in-house data processor comprises an in-house processing host server. The in-house processing host server comprises a second microcomputer unit. The second microcomputer unit comprises a second memory subunit. The second memory subunit comprises a server-side proprietary mobile application software. The server-side proprietary mobile application software comprises the acoustic/audio fingerprint generator facilitating automatically and autonomously generating corresponding audio fingerprints of the captured audio contents from all the programs available for display on the TV channels. The server subsystem further comprises an external cloud-based host server. The external cloud-based host server comprises a third microcomputer unit. The third microcomputer unit comprises a third memory subunit. The third memory subunit comprises a cloud-based database and an acoustic/audio fingerprint comparator facilitating automatically and autonomously comparing the audio fingerprints generated by the portable computing and communications devices versus the audio fingerprints generated by the in-house data processor comprising the in-house processing host server, wherein the external cloud-based host server facilitates automatically and autonomously determining which one or more of the users is watching which one or more of the programs on which one or more of the TV channels based on the results of the comparison, and wherein the external cloud-based host server facilitates automatically and autonomously sending the matched results of the comparison for the determined users to the cloud-based database of for storage and further processing, and wherein the external cloud-based host server facilitates automatically and autonomously generating a comprehensive viewership profile information for the determined users, and wherein the external cloud-based host server facilitates utilizing the comprehensive viewership profile for one or more content monetization opportunities.

A method for second screen real-time engagement. The method comprises at least one of inputting and transmitting a plurality of second screen information items comprising one or more input audio fingerprints, second screen engagement contents and formats therefor, from one or more external content sources to an external cloud-based host server comprising a cloud-based database, automatically and autonomously generating corresponding audio fingerprints of the captured audio contents from all the programs available for display on the TV channels using an in-house data processor comprising one or more in-house processing host servers and Set-Top Boxes (STBs) for transmission to the external cloud-based host server comprising the cloud-based database, automatically and autonomously comparing the at least one of inputted and transmitted plurality of second screen information items comprising the one or more input audio fingerprints versus the audio fingerprints of the captured audio contents from all the programs available for display on the TV channels, upon finding one or more matches, transmitting the instantly matched input audio fingerprints corresponding to one or more given TV channels to the portable computing and communications devices whose users are currently watching the TV to confirm whether the users are watching the matched TV channels, upon confirmation, transmitting the audio fingerprints of the matched TV channels, second screen engagement contents and formats therefor to the portable computing and communications devices, upon reception of the matched TV channels, at least one of periodically, adaptively, dynamically, customizably, and via a combination thereof, automatically capturing audio content from a program currently displayed on the TV channel using the portable computing and communications devices, automatically and autonomously generating corresponding audio fingerprint of the captured audio content from the program currently displayed on the TV channel and upon matching of the audio fingerprint of the at least one of the incoming and received audio fingerprint content from the captured audio fingerprint of the program currently displayed and watched on the TV channel, displaying the second screen content on the portable computing and communications device based on the second screen engagement content, in accordance with the format therefor.

These and other systems, processes, methods, objects, features, and advantages of the present invention will be apparent to those skilled in the art from the following detailed description of the preferred embodiment and the drawings. All documents mentioned herein are hereby incorporated in their entirety by reference.

### BRIEF DESCRIPTION OF THE DRAWINGS

FIG. 1A depicts a block diagrammatic representation of a system for overall management of TV channel content based on acoustic fingerprinting using portable computing and communications devices, thereby facilitating content identification, content enhancement, audience management, broadcast monitoring and content monetization, according to one or more embodiments;

FIG. 1B depicts a context-level schematic, block diagrammatic representation of the system for TV channel content management and monetization based on audio (or acoustic) fingerprinting using portable computing and communications devices, according to one or more embodiments;

FIG. 2 depicts a context-level schematic, block diagrammatic representation of the system of the present invention facilitating real-time second screen engagement, according to one or more embodiments; and

FIGS. 3A-B depict a flow diagram for a method for overall management of TV channel content based on acoustic fingerprinting using portable computing and communications devices, thereby facilitating content identification, content enhancement, audience management, broadcast monitoring and content monetization, according to one or more embodiments; and

FIG. 4 depicts a computer system that may be a computing device and may be utilized in various embodiments of the present invention.

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

While the method and system is described herein by way of example for several embodiments and illustrative drawings, those skilled in the art will recognize that the method and system for TV channel content management and monetization based on content fingerprinting using a portable computing and communications device, is not limited to the embodiments or drawings described. It should be understood, that the drawings and detailed description thereto are not intended to limit embodiments to the particular form disclosed. Rather, the intention is to cover all modifications, equivalents and alternatives falling within the spirit and scope of the method and system for TV channel content management and monetization based on content fingerprinting using a portable computing and communications device defined by the appended claims. Any headings used herein are for organizational purposes only and are not meant to limit the scope of the description or the claims. As used herein, the word “may” is used in a permissive sense (i.e., meaning having the potential to), rather than the mandatory sense (i.e., meaning must). Similarly, the words “include”, “including”, and “includes” mean including, but not limited to.

### DETAILED DESCRIPTION

Various embodiments of a method and system for TV channel content management and monetization based on audio fingerprinting using a portable computing and communications device are described. In the following detailed description, numerous specific details are set forth to provide a thorough understanding of claimed subject matter. However, it will be understood by those skilled in the art that claimed subject matter may be practiced without these specific details. In other instances, methods, apparatuses or systems that would be known by one of ordinary skill have not been described in detail so as not to obscure claimed subject matter.

Embodiments of the present invention disclose a method for media content management and monetization, and corresponding system therefor. The method comprises automatically and autonomously capturing audio contents at least one of periodically, adaptively, dynamically, randomly, customizably, and via a combination thereof, from programs displayed and viewed on TV channels by users using portable computing and communications devices, automatically and autonomously generating corresponding audio fingerprints of the captured audio contents using the portable computing and communications devices for transmission to at least one of an external cloud-based host server comprising a cloud-based database, automatically and autonomously capturing audio contents continuously from all the programs available for display on the TV channels using an in-house data processor comprising at least one of an in-house processing host server and a Set-Top Box (STB), automatically and autonomously generating corresponding audio fingerprints of the captured audio contents from all the programs available for display on the TV channels using the in-house data processor comprising the in-house processing host server and Set-Top Box (STB) for transmission to the external cloud-based host server comprising the cloud-based database, automatically and autonomously comparing the audio fingerprints generated by the portable computing and communications devices versus the audio fingerprints generated by the in-house data processor comprising the in-house processing host server and Set-Top Box (STB), using the external cloud-based host server comprising the cloud-based database, automatically and autonomously determining which one or more of the users is watching which one or more of the programs on which one or more of the TV channels based on the results of the comparison, automatically and autonomously sending the matched results of the comparison for the determined users to the cloud-based database of the external cloud-based host server for storage and further processing, automatically and autonomously generating a comprehensive viewership profile information for the determined users and utilizing the comprehensive viewership profile for one or more content monetization opportunities.

In some embodiments, overall management of TV contents viewed by one or more users of one or more portable computing and communications devices, whilst using the same, is disclosed, in accordance with the principles of the present invention. Specifically, one or more systems, and corresponding methods therefor, facilitating overall management of the TV contents viewed by the one or more users of the one or more portable computing and communications devices, whilst using the same, for instance mainly via capture, storage and processing of the TV contents, data or information in connection with the viewers thereof, devices concurrently used therewith, and overall context of viewing therefor, is disclosed, in accordance with the principles of the present invention. More specifically, a system, and corresponding method therefor, facilitating overall management of the TV contents viewed by the users of the one or more portable computing and communications devices, whilst using the same, for instance particularly via 1) capturing the TV contents, data or information in connection with the viewers thereof, devices concurrently used therewith, and overall context of viewing therefor, 2) storing the captured TV contents, data or information in connection with the viewers thereof, devices concurrently used therewith, and overall context of viewing therefor, 3) processing A) the at least one of captured and stored TV contents, for example as in TV content recognition, for instance based on Automatic Content Recognition (ACR), by way of content-based fingerprinting, for instance via implementation of acoustic (or audio) fingerprinting comprising acoustic fingerprint generation and comparison, B) data or information in connection with the viewers thereof, the portable computing and communications devices concurrently used therewith, and overall context of viewing therefor, for instance identifying users based on the specific devices used by the users, analyzing the specific device-dependent user data or information, profiling users based on the specific device-dependent user data or information, categorizing users based on the profiles, recommending TV or other contents partly based on user profile and overall context of viewing, in turn, facilitating content identification, content enhancement, audience management, for instance audience analysis, profiling, measurement, enhancement of participation thereof, monetizing audience information and broadcast monitoring is disclosed, in accordance with the principles of the present invention.

Further, a system, and corresponding method therefor, facilitating at least one of automatically periodically, adaptively (as per need or need-based), dynamically (as and when), randomly, customizably, and via a combination thereof, capturing the TV contents, processing the captured TV contents, i.e. acoustic fingerprint generation and comparison, identifying the processed TV contents, content enhancement, audience management, for instance audience measurement, enhancement of audience participation and comprehensive TV viewership profiling of the viewers, and broadcast monitoring is disclosed, in accordance with the principles of the present invention. Stated differently, a system, and corresponding method therefor, facilitating capturing the TV contents at least one of automatically periodically, adaptively (as per need or need-based), dynamically (as and when), randomly, customizably, and via a combination thereof, processing the captured TV contents, i.e. acoustic fingerprint generation and comparison, identifying the processed TV contents (or content recognition or identification), enhancing the recognized or identified content (or content enhancement), managing audience (or audience management), for instance measuring audience (or audience measurement), engaging audience (or audience engagement), enhancing audience participation (or enhancement of audience participation) and audience profiling (or comprehensive TV viewership profiling of the viewers), and broadcast monitoring is disclosed, in accordance with the principles of the present invention.

In some embodiments, the systems, and the corresponding methods therefor, facilitate overall management of contents of one or more broadcasting media, using at least one of audio, video and content fingerprinting, matching and targeting, viewed by one or more users of, or owning and operating, one or more portable computing and communications devices. For example, and in no way limiting the scope of the invention, the one or more broadcasting media comprise at least one of a radio broadcasting radio programs, cable radio or FM, satellite radio, telephone, teletext, Television (TV) broadcasting TV programs, cable TV, satellite TV, Internet TV, webcast, streaming media, Web TV, peer-to-peer TV, time-shifted TV, Live TV and Video on Demand (VOD), all of the foregoing capable of broadcasting at least one of audio, for instance radio channels, songs, audio-visual, for instance presentations, audio-video (video), for instance movies, online video, multimedia, for instance text, still images (visuals), animation, interactive content forms, and combinations thereof.

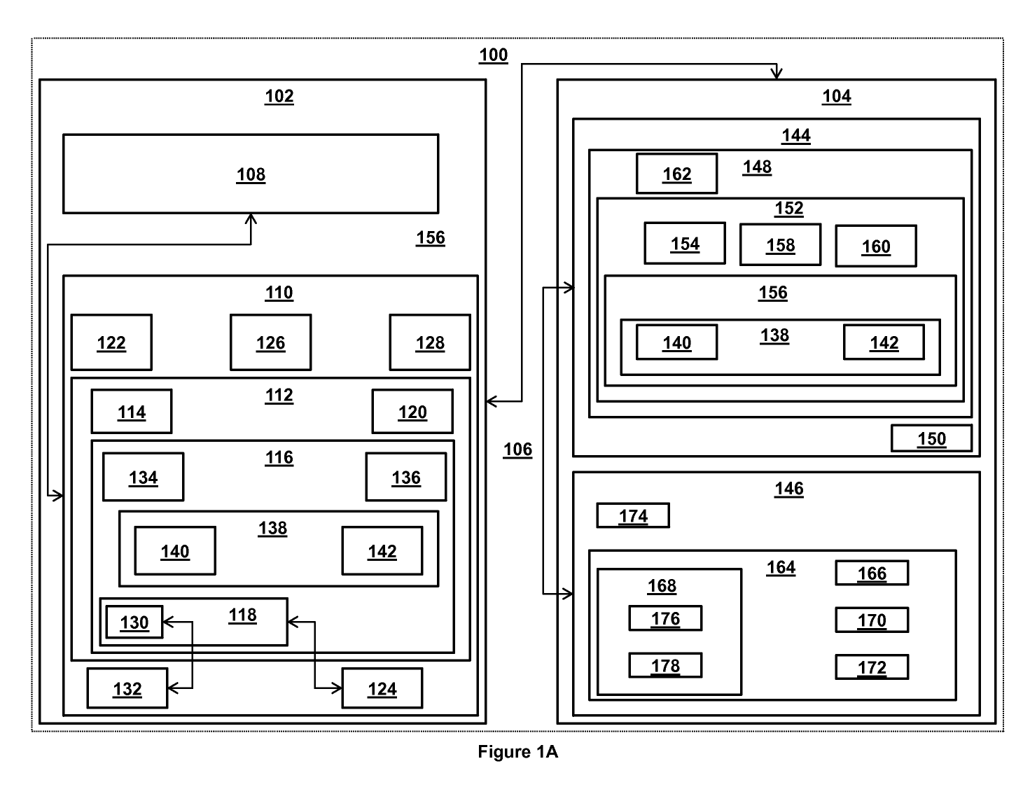

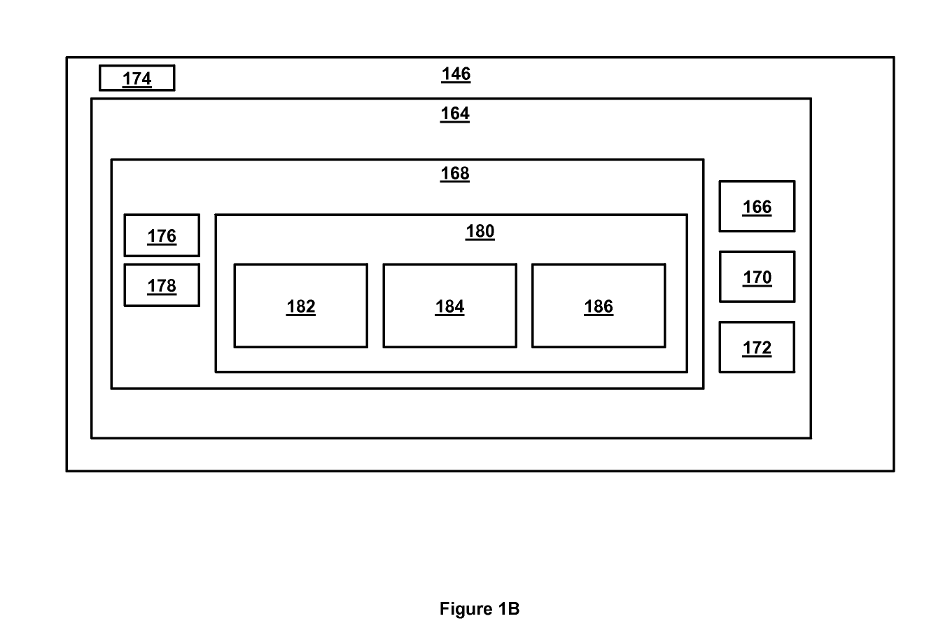

FIG. 1A depicts a block diagrammatic representation of a system for overall management of TV channel content based on acoustic fingerprinting using portable computing and communications devices, thereby facilitating content identification, content enhancement, audience management, broadcast monitoring and content monetization, according to one or more embodiments.

With reference to FIG. 1A, in one or more embodiments, the system 100, and corresponding method therefor, facilitates overall management of TV contents viewed by one or more users of one or more portable computing and communications devices, whilst using the same. Specifically, the system 100, and the method therefor, facilitates overall management of the TV contents viewed by the users of the one or more portable computing and communications devices, whilst using the same, for instance mainly via capturing, storing and processing the TV contents, data or information in connection with the viewers thereof, devices concurrently used therewith, and overall context of viewing therefor. More specifically, the system 100, and corresponding method therefor, facilitates overall management of the TV contents viewed by the users of the one or more portable computing and communications devices, whilst using the same, for instance particularly via 1) capturing the TV contents, data or information in connection with the viewers thereof, devices concurrently used therewith, and overall context of viewing therefor, 2) storing the captured TV contents, data or information in connection with the viewers thereof, devices concurrently used therewith, and overall context of viewing therefor, 3) processing A) the at least one of captured and stored TV contents, for example as in TV content recognition, for instance based on Automatic Content Recognition (ACR), by way of content-based fingerprinting, for instance via implementation of acoustic (or audio) fingerprinting comprising acoustic fingerprint generation and comparison, and B) processing data or information in connection with the viewers thereof, the portable computing and communications devices concurrently used therewith, and overall context of viewing therefor, for instance identifying users based on the specific devices used by the users, analyzing the specific device-dependent user data or information, profiling the users based on the specific device-dependent user data or information, categorizing the users based on the profiles, recommending TV or other contents to the users partly based on user profile and overall context of viewing therefor, in turn, facilitating content management, for instance content identification, content analysis, content profiling, content categorization, content recommendation, content efficacy tracking and content enhancement, audience management, for instance audience identification, audience analysis, audience profiling, audience segmentation, audience measurement, audience participation enhancement, monetizing audience information and broadcast monitoring, context management, for instance context analysis, context profiling and context-based recommendation, is disclosed, in accordance with the principles of the present invention. Still more specifically, audience profiling further comprises comprehensive TV viewership profiling of the users (or viewers) viewing the TV contents, whilst using the one or more portable computing and communications devices. Further, the system 100, and the method therefor, facilitates processing the comprehensive TV viewership profiling information. Still further, the system 100, and the method therefor, facilitates monetizing the comprehensive TV viewership profiling information.

Specifically, comprehensive TV viewership profiling of the users (or viewers) viewing the TV contents further comprises automatically identifying the viewers watching the TV contents, determining or identifying the TV contents viewed or watched by the identified viewers, determining the location of the viewers viewing the TV contents, determining the time period or duration of watching the TV contents, and the like. More specifically, comprehensive TV viewership profiling of the users (or viewers) viewing the TV contents further comprises 1) capturing the TV contents, data or information in connection with the viewers thereof, devices concurrently used therewith, and overall context of viewing therefor, 2) storing the captured TV contents, data or information in connection with the viewers thereof, devices concurrently used therewith, and overall context of viewing therefor, 3) processing A) the at least one of captured and stored TV contents and data or information in connection with the viewers thereof, the portable computing and communications devices concurrently used therewith, and overall context of viewing therefor, for instance recognizing TV contents viewed by the users, identifying users based on the specific devices used by the users, analyzing the specific device-dependent user data or information, profiling users based on the specific device-dependent user data or information, categorizing users based on the profiles, recommending TV or other contents partly based on user profile, and overall context of viewing therefor.

Still more specifically, the system 100 facilitates automatically identifying who, i.e. which specific users, is viewing what, i.e. what specific contents, for instance TV advertisements and programs, and engaging the users on the portable computing and communications devices owned by the users through second screen contents.

In some embodiments, the system 100 facilitates identifying the viewers via capturing one or more unique identifiers associated with, or identifying, the viewers (users) based on one or more portable computing and communications devices used by the viewers, for instance at least one of the International Mobile Subscriber Identity (IMSI), Mobile Equipment Identifier (MEID), International Mobile Station Equipment Identity (IMEI), OS driven IDs associated with portable computing and communications devices, such as ANDROID™ ID and advertiser ID assigned by ANDROID™′ Universally Unique Identifier (UDID) and advertising ID assigned by iOS®, and a combination thereof.

As depicted in FIG. 1A, broadly, the system 100 comprises a client subsystem 102, server subsystem 104 and network subsystem 106.

The client and server subsystems 102 and 104 are wirelessly coupled through the network subsystem 106. For instance, in some embodiments, the network subsystem 106 is at least one of wired, wireless network, and a combination thereof.

The client subsystem 102 is in essence a data input/feed subsystem 102. For purposes of clarity and expediency, the terms “client subsystem” and “data input/feed subsystem” may be hereinafter intermittently interchangeably used.

The data input/feed subsystem 102 comprises at least one TV 108 and at least one portable computing and communications device 110 owned and operated by the one or more users (or viewers) viewing the TV 108.

In some embodiments, each of the portable computing and communications devices is at least one of a portable computing device, portable communications device and a combination thereof, for instance a portable computing and communications device. In some embodiments, each of the portable computing devices is at least one of a portable computer, tablet computer, Personal Digital Assistant (PDA), an ultra mobile PC, a smart phone, carputer, portable communications, pentop computer, and the like. Likewise, in some embodiments, each of the portable communications devices is at least one of a mobile device, and the like.

In some embodiments, the data input/feed subsystem facilitates receiving TV contents, displaying, capturing, storing and processing the TV contents viewed by the one or more users (viewers) of the one or more portable computing and communications devices. Specifically, the data input/feed subsystem facilitates at least one of automatically periodically, adaptively, dynamically, randomly, in a customized fashion, and a combination thereof, capturing audio data in the TV contents viewed by the users of the portable computing and communications devices, converting the captured audio data for generating corresponding acoustic/audio fingerprint data or information. Further, the data input/feed subsystem facilitates transmitting the acoustic/audio fingerprint data or information to the server subsystem, in turn, facilitating automatic recognition (or detection or identification) of the TV contents viewed by the users, in real-time, based on acoustic fingerprint comparison.

The data input/feed subsystem 102 is wirelessly coupled to the server subsystem 104 via the network subsystem 106. Specifically, the portable computing and communications device 110 is wirelessly coupled to the server subsystem 104 via the network subsystem 106.

The TV 108 facilitates transmission of TV program contents displayed on one or more TV channels viewed by the user of the portable computing and communications device 110.

The portable computing and communications device 110 facilitates capturing and processing the TV program contents displayed on one or more channels viewed by the user at least one of automatically periodically, adaptively, dynamically, randomly, in customized fashion, and a combination thereof.

The portable computing and communications device 110 comprises a first microcomputer unit 112. The first microcomputer unit 112 comprises a first microprocessor subunit 114, first memory subunit 116, first Input/Output (I/O) subunit 118 and first support circuits 120, respectively. In addition, the portable computing and communications device 110 comprises a first wireless communication transceiver subunit 122. Further, in addition, the portable computing and communications device 110 optionally comprises a first display subunit 124. Specifically, the first display subunit 124 is coupled to the first Input/Output (I/O) subunit 118. For example, and in no way limiting the scope of the invention, the first display subunit 124 is a touch-sensitive display facilitating capturing or inputting user touch inputs. In some embodiments, the portable computing and communications device 110 may comprise a first GPS subunit 126 and a first GPRS subunit 128.

In some embodiments, the first Input/Output (I/O) subunit 118 additionally comprises an audio Input/Output (I/O) port 130. The audio Input/Output (I/O) port 130 is coupled to a microphone 132.

In operation, the microphone 132 of the first Input/Output (I/O) subunit 118 of the portable computing and communications device 110 captures the audio data or information in the TV contents. Specifically, the microphone 132 captures the audio data or information in the TV contents viewed by the user of the portable computing and communications device 110 at least one of automatically, i.e. without any user (or manual) intervention (or input), periodically, adaptively, dynamically, randomly, in a customized fashion, and a combination thereof.

In some scenarios, for example, and in no way limiting the scope of the invention, the portable computing and communications device 110 is a smartphone. The smartphone 110 comprises of the features of a mobile phone and another consumer device, such as at least one of a PDA, media player, digital camera, GPS navigation unit and a combination thereof. In addition, the smartphone 110 comprises of the features of a touchscreen computer, including web browsing, Wi-Fi and Third (or 3rd)-part application software.

The first memory subunit 116 comprises of an Operating System (OS) 134 and a Software Development Kit (SDK) 136 and proprietary mobile application software (or mobile app or app) 138. For purposes of clarity and expediency, the proprietary mobile application software (or mobile app or app) 138 is in essence the client-side of the proprietary mobile application software (or mobile app or app) 138. In some embodiments, the SDK 136 facilitates development of the proprietary mobile application software (or mobile app or app) 138.

In some embodiments, for example, and in no way limiting the scope of the invention, the OS 134 is a mobile OS.

In operation, an OS, for instance the mobile OS 134 facilitates operating a portable computing and communications device, for instance the smartphone 110, tablet, PDA, or other mobile device. In some scenarios, the mobile OS 134 facilitates combining the features of a Personal Computer (PC) OS with other features including, but not limited to, a touchscreen, cellular network and frequencies therefor, BLUETOOTH®, Wi-Fi, GPS mobile navigation, camera, video camera, speech recognition, voice recorder, music player, Near Field Communication (NFC) and infrared blaster.

In some embodiments, the smartphone 110 comprises two mobile OSs, namely first main user-facing software platform and an optional second low-level proprietary real-time OS (both not shown and numbered here explicitly). The second low-level proprietary real-time OS facilitates supplementing the first main user-facing software platform, thereby resulting in operation of the radio and other hardware.

For example, and in no way limiting the scope of the invention, the mobile OS 134 is at least one of ANDROID™, SAMSUNG BADA OS®, BLACKBERRY®, FIREFOX® OS, iOS, PALM OS®, SYMBIAN™, WINDOWS MOBILE™, and the rest.

As used in general, the term “acoustic fingerprint” refers to a condensed digital summary, deterministically generated from an audio signal, thereby facilitating identification (or detection or recognition) of an audio sample, and thus location, access and retrieval of similar items in an audio database based on acoustic fingerprint comparison.

The proprietary mobile application software 138 is based on a robust acoustic fingerprint algorithm. Specifically, the acoustic fingerprint algorithm takes into consideration the perceptual characteristics of the captured audio signals. In use, the microphone 132 at least one of automatically, i.e. without any user (or manual) intervention (or input), periodically, adaptively, dynamically, and a combination thereof, captures the audio data or information in the TV contents viewed by the user of the portable computing and communications device 110. For example, and in no way limiting the scope of the invention, the one or more perceptual characteristics often exploited by acoustic or audio fingerprints includes zero crossing rate, estimated tempo, average spectrum, spectral flatness, prominent tones across a set of bands, bandwidth and the like. In some scenarios involving two audio files sounding alike to the human ear, the acoustic fingerprints of the two audio files may match, despite the fact that the binary representations of the two audio files may be quite different. Thus, the acoustic fingerprints are not bitwise fingerprints, which must be sensitive to any small change in the audio data. As a consequence, acoustic fingerprints are more analogous to human fingerprints, wherein small variations that are insignificant to the features the fingerprints use are tolerated. Further, an analogy is developed amid a smeared human fingerprint impression, which can be accurately matched to another fingerprint sample in a reference database, and acoustic fingerprints as they work in a similar way.

For purposes of clarity and expediency, the proprietary mobile application software 138 is hereinafter interchangeably referred to as an acoustic/audio content management application software 138 and acoustic/audio content manager 138.

In some embodiments, the acoustic/audio content management application software 138 comprises an acoustic/audio fingerprint generator 140 and an acoustic/audio fingerprint generation optimizer 142.

In operation, the acoustic/audio fingerprint generation optimizer 142 facilitates optimizing generation of acoustic/audio fingerprints, thereby minimizing consumption of the data of the portable computing and communications device 110 and battery therefor. Specifically, the acoustic/audio fingerprint generation optimizer 142 facilitates optimizing the generation of acoustic/audio fingerprints based on managing or maintaining a trade-off between one or more parameters, such as 1) the time consumed, for instance in a task of at least one of customized, adaptive, dynamic, random, and a combination thereof, variation or modification of the sampling interval, specifically the periodicity of the cycle for capturing the audio data in the TV contents viewed by the user of the portable computing and communications device 110, whether particularly in computation or in general response time, 2) the space occupied, for instance the amount of memory consumed in performing the aforementioned task of capturing, whether primary, such as in Random Access Memory (RAM) or secondary, such as on a hard disk drive, of the first memory subunit 116 of the portable computing and communications device 110, 3) the location of the portable computing and communications device 110 used in performing the aforementioned task, 4) the current viewing status of the user, for instance whether or not the user is currently watching the TV, 5) the energy consumed, for instance the amount of battery consumed in performing the aforementioned task, and other battery state management parameters.

In some embodiments, the portable computing and communications device comprises battery management application software or battery manager. The battery management application software facilitates managing a rechargeable battery (cell or battery pack), such as by protecting the battery from operating outside its Safe Operating Area (SOA), monitoring the state thereof, calculating secondary data, reporting that data, controlling the environment thereof, authenticating the battery, and balancing the same. The battery management application software facilitates monitoring the state of the battery as represented by various parameters, such as A) voltage, for instance total voltage, voltages of individual cells, minimum and maximum cell voltage or voltage of periodic taps, B) temperature, for instance average temperature, coolant intake temperature, coolant output temperature, or temperatures of individual cells, C) the State of charge (SOC) or Depth of Discharge (DOD) to indicate the charge level of the battery, D) State of health (SOH), a variously-defined measurement of the overall condition of the battery, and E) current, for instance current in or out of the battery, and the like.

In some embodiments, optimization of space and time parameters is accomplished via code or program or software optimization based on modification of the acoustic/audio content management application software, and the acoustic/audio fingerprint generator thereof, to make certain aspects thereof work more efficiently or use fewer resources. For example, and in no way limiting the scope of the invention, in general, the acoustic/audio content management application software, and the acoustic/audio fingerprint generator thereof is optimized so as execute the same relatively faster, or operate with less memory storage or other resources, or draw less power from the battery.

Advantageously, in some embodiments, the acoustic/audio fingerprint generation optimizer 142 facilitates collecting (or capturing or acquiring) data or information at a large scale, for instance in the order of one or more millions of users, through the portable computing and communications devices, thereby facilitating audience management, for instance audience analysis, TV viewership analytics, audience profiling, audience measurement, enhancement of audience participation thereof, monetizing audience information, and the like. Specifically, the acoustic/audio content management application software 138, the acoustic/audio fingerprint generator 140 and acoustic/audio fingerprint generation optimizer 142 thereof, facilitate TV viewership data (or information) or audience analytics with enhanced qualitative and quantitative parameters of merit, such as minimal investment, large scale, and high economic feasibility, vis-à-vis traditional audience measurement methods, such as peoplemeters, Target Rating Points (TRPs), Home Using Television (HUT), Persons Using TV or People Using Television (PUT), Gross Rating Points (GRPs), which are deployed on a small sample at a much higher cost per user.

In some scenarios, in use, the acoustic fingerprint is used for assortment of practical applications, including but not limited to, identification of audio data, such as songs, melodies, tunes, advertisements, sound effect library management and video file identification. In some scenarios, in use, media identification using acoustic fingerprints is used to monitor the use of specific musical works and performances on radio broadcasts, records, Compact Discs (CDs) and peer-to-peer networks, thereby facilitating copyright compliance, licensing, and other monetization schemes.

In some scenarios, one or more audio compression techniques, for instance Advanced Audio Coding (AAC), Moving Pictures Experts Group-1 or -2 Audio Layer III (MPEG-1 or MPEG-2 Audio Layer III) or MP3, Windows Media Audio (WMA), Vorbis, cause radical changes to the binary encoding of an audio file, without radically affecting the way the sound of the audio file is perceived by the human ear. In some scenarios involving deployment of the aforementioned audio compression techniques to radically change the binary encoding of audio files, whilst not radically affecting the human perception of the sound of the audio file, upon subjecting a recording to the aforementioned audio compression techniques, a robust acoustic fingerprint facilitates identifying the recording, even if the audio quality has been reduced significantly.

In some embodiments, the SDK comprises a set of software development tools, thereby facilitating creation of applications.

As depicted in FIG. 1A, the server subsystem 104 comprises an in-house data processor 144 and one or more external cloud-based host servers 146. The in-house data processor 144 comprises one or more in-house processing host servers 148 and one or more Set-Top Boxes (STBs) 150. The in-house data processor 144 and one or more external cloud-based host servers 146 are wirelessly coupled through the network subsystem 106.

Each of the in-house processing host servers 148 comprises a second microcomputer unit 152. The second microcomputer unit 152 comprises a second microprocessor subunit 154, second memory subunit 156, second Input/Output (I/O) subunit 158 and second support circuits 160, respectively. In addition, each of the in-house processing host servers 148 comprises a second wireless communication transceiver subunit 162.

Each of the STBs 150 comprises a TV-tuner input (not shown and numbered here explicitly). The TV-tuner (not shown and numbered here explicitly) facilitates converting a Radio Frequency (RF) analog television or digital television transmission into audio and video signals, which are further processed to produce sound and picture. Each of the STBs 150 facilitates displaying output. Each of the STBs 150 facilitates converting signals from an external signal source (not shown and numbered here explicitly) into contents displayable on at least one of TVs 108. For example, each of the STBs 150 is used in Cable Television (CATV), satellite television, and Over-the-Air (OTA) TV systems, etc.

The in-house data processor 144 facilitates automatically, continuously capturing, storing and processing TV channel program contents, i.e. acoustic/audio fingerprint generation, displayed on at least one of the TVs 108. In addition, the in-house data processor 144 facilitates transmitting the fingerprints to at least one of the external cloud-based host servers 146 for further processing. Further, the in-house data processor 144 facilitates conversion of all TV channels streams into corresponding acoustic/audio (frequency) fingerprints. Specifically, the second memory subunit 156 of the at least one of the in-house processing host servers 148 of the in-house data processor 144 comprises the server-side of the acoustic/audio content manager 138. Reiterating again, the server-side acoustic/audio content management application software 138 comprises the acoustic/audio fingerprint generator 140 and the acoustic/audio fingerprint generation optimizer 142.

Likewise, each of the external cloud-based host servers 146 comprises a third microcomputer unit 164. The third microcomputer unit 164 comprises a third microprocessor subunit 166, third memory subunit 168, third Input/Output (I/O) subunit 170 and third support circuits 172, respectively. In addition, each of the external cloud-based host servers 146 comprises a third wireless communication transceiver subunit 174.

For example, and in no way limiting the scope of the invention, the external cloud-based host server 146 is capable of hosting and running an AMAZON™ cloud server. In some scenarios, the external cloud-based host server 146 is an Internet connected computing and communications device. For example, and in no way limiting the scope of the invention, the external cloud-based host server is AMAZON™ AWS®, MICROSOFT® AZURE®, HP Cloud, Google Cloud Compute, CSC CLOUD COMPUTE® etc.

The third memory subunit 168 of each of the external cloud-based host servers 146 comprises an acoustic/audio fingerprint comparator 176 and a cloud-based database 178. In operation, each of the external cloud-based host servers 146 is capable of facilitating comparing content-based fingerprints from the portable computing and communications devices 110 and in-house data processor 144. Specifically, each of the external cloud-based host servers 146 facilitates comparing the acoustic/audio fingerprints from the portable computing and communications devices 110 versus the acoustic/audio fingerprints from the in-house data processor 144.

Each of the external cloud-based host servers 146 facilitates determining or confirming whether or not a given user is watching or viewing a given TV channel, based on the quality of match.

Each of the external cloud-based host servers 146 facilitates storing the confirmed quality matched watching information to the cloud-based database 178.

The cloud-based database 178 facilitates generating comprehensive TV viewership information corresponding to the portable computing and communications devices 110. The comprehensive TV viewership information comprises one or more records corresponding to each of the portable computing and communications devices 110, which is owned and operated by each of the users viewing each of the TVs 108, on the network subsystem 106. Each record comprises one or more qualitative and quantitative attributes in connection with one or more parameters, namely channels, shows, and advertisements viewed on the TVs 108.

In some embodiments, at least one of 1) generation of one or more new and identification, analysis, selection and capitalization of one or more available monetization opportunities is disclosed, in accordance with the principles of the present invention. Specifically, the system, and the method therefor, facilitates identification, analysis, selection and capitalization of one or more available data monetization opportunities, in accordance with the principles of the present invention. More specifically, the system, and the method therefor, facilitates data monetization via generating revenue from at least one of available data sources and real time streamed data by instituting the discovery, capture, storage, analysis, dissemination, and use of the aforementioned data. Stated differently, the system, and the method therefor, facilitates data monetization by virtue of which data producers, data aggregators, data distributors and data consumers, for instance large and small, exchange sell or trade data. Still more specifically, data monetization leverages data generated through business operations as well as data associated with individual actors and with electronic devices and sensors participating in a given network, for instance Internet of Things (IOT). The ubiquity of the IOT facilitates generating location data and other data from sensors and mobile devices, for instance the portable computing and communications devices. In some scenarios involving collation of the aforementioned data against traditional databases, the value and utility of both the aforementioned sources of data increases, leading to tremendous potential to mine data for social good, research and discovery, and achievement of business objectives. Closely associated with data monetization are the emerging data as a service models for transactions involving data by the data item.

In some embodiments, the system, and the method therefor, facilitates data monetization comprising A) identifying available data sources, for instance data currently available for monetization as well as other external data sources, which may enhance the value of the data currently available for monetization, B) connecting, aggregating, attributing, validating, authenticating and exchanging data, thereby facilitating converting the data directly into at least one of actionable, revenue generating insight and services, C) setting terms, prices and facilitating data trading, such as methods for data vetting, storage, and access, for example many global corporations have locked and siloed data storage infrastructures, which stymies efficient access to data and cooperative and real time exchange, D) performing research and analytics on data, for instance drawing predictive insights from existing data as a basis for using data to at least one of reduce risk, enhance product development, performance, improve customer experience and business outcomes, E) performing action and leveraging data, such as determining at least one of alternative and improved data-centric products, solutions, ideas, or services, for example real time actionable triggered notifications or enhanced channels, such as web or mobile response mechanisms.

In some embodiments, the system, and the method therefor, facilitates determining one or more pricing variables and factors in connection with data monetization, in accordance with the principles of the present invention. For example, and in no way limiting the scope of the invention, the one or more pricing variables and factors comprise 1) fee for use of a platform to connect buyers and sellers, 2) fee for use of a platform to configure, organize, and otherwise process data included in a data trade, 3) fee for connecting or including a device or sensor into a data supply chain, 4) fee for connecting and credentialing a creator of a data source and a data buyer, for instance often through a federated identity, 5) fee for connecting a data source to other data sources to be included into a data supply chain, 6) fee for use of an internet service or other transmission service for uploading and downloading data, for instance sometimes for an individual, through a personal cloud, 7) price or exchange or other trade value assigned by a data creator or generator to a data item or a data source, 8) price or exchange or other trade value offered by a data buyer to a data creator, 9) price or exchange or other trade value assigned by a data buyer for a data item or a data source formatted according to criteria set by a data buyer, 10) incremental fee assigned by a data buyer for a data item or a data set scaled to the reputation of the data creator, 11) fee for use of encrypted keys to achieve secure data transfer, 12) fee for use of a search algorithm specifically designed to tag data sources that contain data points of value to the data buyer, 13) fee for linking a data creator or generator to a data collection protocol or form, 14) fee for server actions, for instance a notification triggered by an update to a data item or data source included into a data supply chain, and the rest.

In some embodiments, the system, and the method therefor, facilitates capitalizing monetization opportunities based on audience management data or information, in accordance with the principles of the present invention. Specifically, the system, and the method therefor, facilitates capitalizing monetization opportunities based on audience management data or information comprising data or information obtained from audience analysis, audience profiling, for instance comprehensive TV viewership profiling, audience measurement, and the like, in accordance with the principles of the present invention.

In some embodiments, targeted delivery of mobile advertisements based on the comprehensive TV viewership profile of the users of the portable computing and communications devices is disclosed, in accordance with principles of the present invention. Specifically, the system, and the method therefor, facilitates capturing the data or information of the users, and in connection therewith, for instance viewing behaviour, context and history thereof, analyzing the captured data or information, profiling the users based on the analyzed data or information, categorizing the users based on the profiles, recommending contents, and tracking efficacy of the recommended contents.

In some scenarios, the system, and the method therefor, facilitates analyzing TV channels and comprehensive viewership of TV programs displayed thereupon in connection with the users of the portable computing and communications devices, in accordance with principles of the present invention.

FIG. 1B depicts a context-level schematic, block diagrammatic representation of the system for TV channel content management and monetization based on audio (or acoustic) fingerprinting using portable computing and communications devices, according to one or more embodiments.

With reference to FIGS. 1A-B, the third memory subunit 168 of each of the external cloud-based host servers 146 comprises a data or an information monetizer application 180. Specifically, the data or information monetizer 180 comprises a TV channel analyzer, disseminator and audience measurer (or measurement application) 182, thereby facilitating analyzing TV channels and comprehensive viewership of TV programs (or program contents) displayed thereupon in connection with the users of the portable computing and communications devices 110. Specifically, in operation, the TV channel analyzer, disseminator and audience measurement application 182 facilitates linking and housing (or storing) data or information from TV channels for analysis to provide business and in particular customer and marketing intelligence, thereby guiding effective and successful decision-making.

Yet again, with reference to FIGS. 1A-B, the data or information monetizer application 180 further comprises a targeted mobile advertisement application 184 for targeted delivery of mobile advertisements based on comprehensive viewership of the users of the portable computing and communications devices 110. For example, and in no way limiting the scope of the invention, targeted mobile advertising is based on various traits of consumers, such as demographics, psychographics, behavioral variables, for instance product, solution or service purchase history, and firmographics, or other second-order activities, which serve as a proxy for the aforementioned traits.

With reference to FIGS. 1A-B, the data or information monetizer application 180 further comprises a targeted in-app engagement application 186 facilitating engagement with at least one of products, solutions and services available for, or for, sale for smartphone users based on comprehensive viewership of the users of the portable computing and communications devices 110.

In some embodiments, the system, and the method therefor, facilitates second screen engagement, in accordance with principles of the present invention.

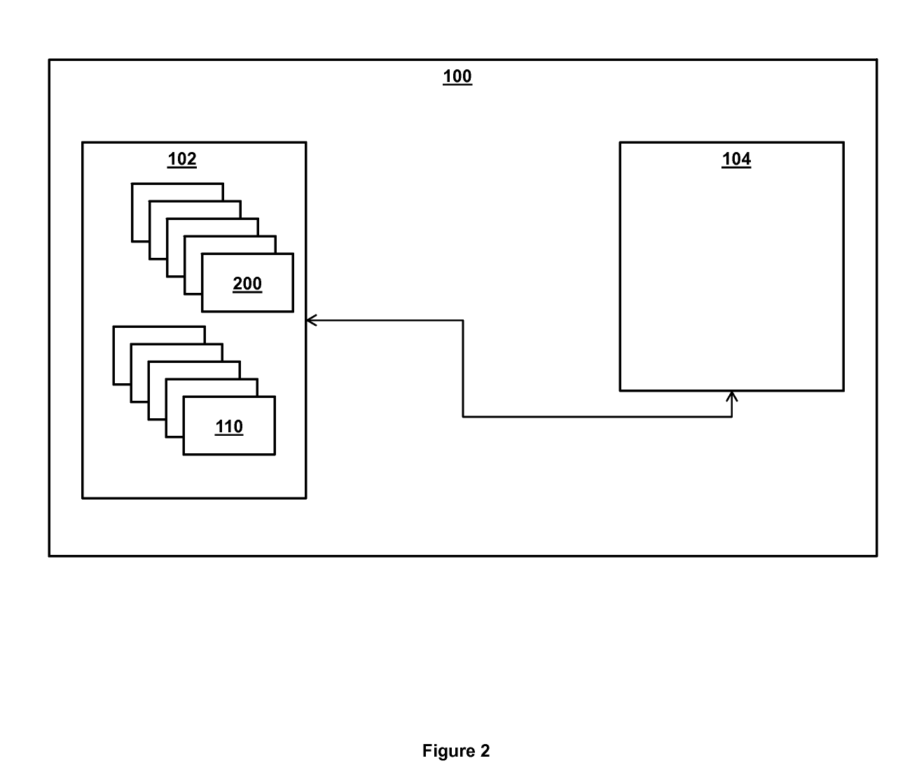

FIG. 2 depicts a context-level schematic, block diagrammatic representation of the system of the present invention facilitating real-time second screen engagement, according to one or more embodiments.

With reference to FIGS. 1A-B and 2, the system 100 comprises the client subsystem 102, server subsystem 104 and network subsystem 106.

As depicted in FIG. 2, the client subsystem 102 further comprises one or more second screen portable computing and communications devices 200.

Reiterating again, as depicted in FIG. 1A, the server subsystem 104 comprises the in-house data processor 144 and one or more external cloud-based host servers 146. The in-house data processor 144 comprises the one or more in-house processing host servers 148 and one or more Set-Top Boxes (STBs) 150. The in-house data processor 144 and one or more external cloud-based host servers 146 are wirelessly coupled through the network subsystem 106.

The term “second screen” refers to the use of a computing device, such as a mobile device, for instance a tablet or smartphone, to provide an enhanced viewing experience for content on another device, such as a TV, for instance the at least one of the TVs 108. In particular, the term “second screen” commonly refers to the use of such devices to provide interactive features during “linear” content, such as a television program, served within a special app or real-time video highlights on social networking apps, such as Facebook® and Twitter®. The use of a second screen supports social television.

In some embodiments involving real-time second screen engagement with TV content, for instance TV advertisements, the one or more second screen portable computing and communications devices 200 facilitate inputting acoustic/audio (or frequency) fingerprints of the TV advertisements, second screen engagement content and format therefor.

In some scenarios involving real-time second screen engagement with TV content, the one or more second screen portable computing and communications devices 200 facilitate inputting one or more attributes of TV channels visited, viewed and engaged, such as channel name, channel frequency, duration or time period of engagement, second screen engagement content and format therefor.

In some scenarios involving implementation of digital sports fan engagement via deployment of the present system, and the method therefor, the one or more second screen portable computing and communications devices 200 facilitate widening the sports fan engagement. The second screen portable computing and communications devices 200 facilitate increasing sports fans attention span via allowing multitasking during watching matches in stadium or live in TV, for instance the at least one of the TVs 108, of FIG. 1A. Thus, the second screen portable computing and communications devices 200 facilitate real-time second screen engagement in games and events, in turn, facilitating maximized participation, connectivity and fan loyalty. Using second screen engagement and combining the viewing experience with social interaction tools and techniques facilitate active involvement instead of passive way of consumption. All the emotions and feelings of sports fan are captured through second screen engagement for the better improvement of entertainments.

In some embodiments, one or more applications in the “second screen” are designed to give another form of interactivity to the user and another way to sell advertising content, in accordance with the principles of the present invention. For example, and in no way limiting the scope of the invention, A) transmission of the Masters Golf Tournament application for the iPhone® for rating information and publicity, B) TV programs broadcasting live tweets and comments, C) synchronization of audiovisual content via web advertising, D) applications that extend the content information, E) shows that add on websites thereof content devoted exclusively to the second screen, F) applications that synchronize the content being viewed to the portable device, G) video game console playing with extra data, for instance a map or strategy data, that synchronize with the content being viewed to the portable device, and H) TV discovery application with recommendation, Electronic Program Guide (EPG) live content, and personalization.

Reiterating again, with reference to FIGS. 1A-B and 2, the server subsystem 104 comprises the in-house data processor 144 and one or more external cloud-based host servers 146. The in-house data processor 144 comprises the one or more in-house processing host servers 148 and one or more Set-Top Boxes (STBs) 150. The in-house data processor 144 and one or more external cloud-based host servers 146 are wirelessly coupled through the network subsystem 106.

The in-house data processor 144 facilitates automatically, continuously capturing, storing and processing TV channel program contents, i.e. acoustic/audio fingerprint generation, displayed on at least one of the TVs 108. In addition, the in-house data processor 144 facilitates transmitting the fingerprints to at least one of the external cloud-based host servers 146 for further processing. Further, the in-house data processor 144 facilitates conversion of all TV channels streams into corresponding acoustic/audio (frequency) fingerprints. Specifically, the second memory subunit 156 of the at least one of the in-house processing host servers 148 of the in-house data processor 144 comprises the server-side of the acoustic/audio content manager 138. Reiterating again, the server-side acoustic/audio content management application software 138 comprises the acoustic/audio fingerprint generator 140 and the acoustic/audio fingerprint generation optimizer 142. For example, and in no way limiting the scope of the invention, the one or more external cloud-based host servers 146 comprise an AMAZON™ cloud server. Specifically the external cloud-based host server 146 hosts and runs the AMAZON™ cloud server.

Each of the STBs 150 comprises a TV-tuner input (not shown and numbered here explicitly). The TV-tuner (not shown and numbered here explicitly) facilitates converting a Radio Frequency (RF) analog television or digital television transmission into audio and video signals, which are further processed to produce sound and picture. Each of the STBs 150 facilitates displaying output. Each of the STBs 150 facilitates converting signals from an external signal source (not shown and numbered here explicitly) into contents displayable on a TV. For example, each of the STBs 150 is used in Cable Television (CATV), satellite television, and Over-the-Air (OTA) TV systems, etc.

With reference to FIGS. 1A-B and 2, each of the external cloud-based host servers 146 facilitate comparing or matching one or more parameters, such as average zero crossing rate, estimated tempo, average spectrum, spectral flatness, prominent tones across a set of bands, and bandwidth, constituting the input acoustic/audio (frequency) fingerprints for all TV channels. In some scenarios, in the event that a match(es) is (or are) found in connection with any channel(s), the instant match(es) is (or are) sent to the portable computing and communications devices, for instance a smartphone 110 of FIG. 1, used by viewers currently watching TV, for instance the TV 108, to verify whether or not the matched channel(s) is (or are) being watched. In some scenarios, in the event that the matched channel(s) is (or are) being viewed, at least one of the external cloud-based host servers 146 facilitates transmitting second screen engagement content and format therefor to the portable computing and communications devices, for instance a smartphone 110 of FIG. 1, for display.

As depicted in FIG. 2, the client subsystem 102 further comprises one or more primary and second screen portable computing and communications devices 200.

The primary portable computing and communications devices 110 or 200 facilitate at least one of automatically, periodically, adaptively, dynamically, in a customized fashion, and a combination thereof, capturing, storing and processing the TV contents, i.e. instant acoustic/audio fingerprint generation for a given channel currently displayed on the TV 108. Upon reception or arrival of a given incoming channel acoustic/audio fingerprint, the primary portable computing and communications devices 110 or 200 facilitate capturing the TV contents currently displayed on a given channel, storing the captured TV contents, and generating acoustic/audio fingerprint for the given channel currently displayed on the TV 108. The primary portable computing and communications devices 110 or 200 facilitate acoustic/audio fingerprint matching or comparison. In some scenarios, the acoustic/audio fingerprint matching or comparison is implemented on the primary portable computing and communications devices 110 or 200. In the event that the acoustic/audio fingerprints match, i.e. match(es) is (or are) found, it implies that a given user using the primary portable computing and communications device 110 or 200 is watching or viewing the matched channel on the TV 108. Further, the second screen engagement content received is displayed on at least one of the primary 110 and second screen portable computing and communications devices 200 and in the format specified therefor.

Advantageously, in some embodiments, the system facilitate performance of real-time research and analytics on media content, such as advertisements, TV shows, movies, etc., viewed by users and capture of feedback therefrom. Specifically, the system facilitates identifying or detecting users viewing a given media content at any point in time and capturing the details of the users thereof facilitating comprehensive viewership profiling of the users for consumption in real-time research and analytics, whilst the users are still watching the given media content.

Advantageously, in some embodiments, the system facilitates fully automated second screen engagement without any user or manual intervention.

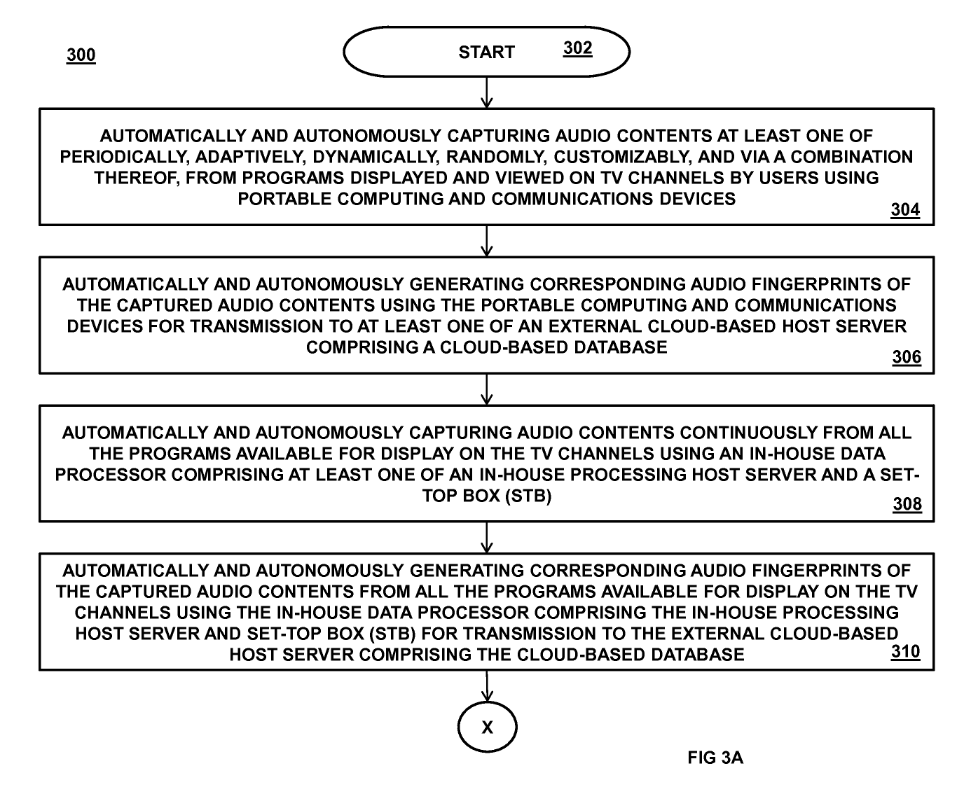

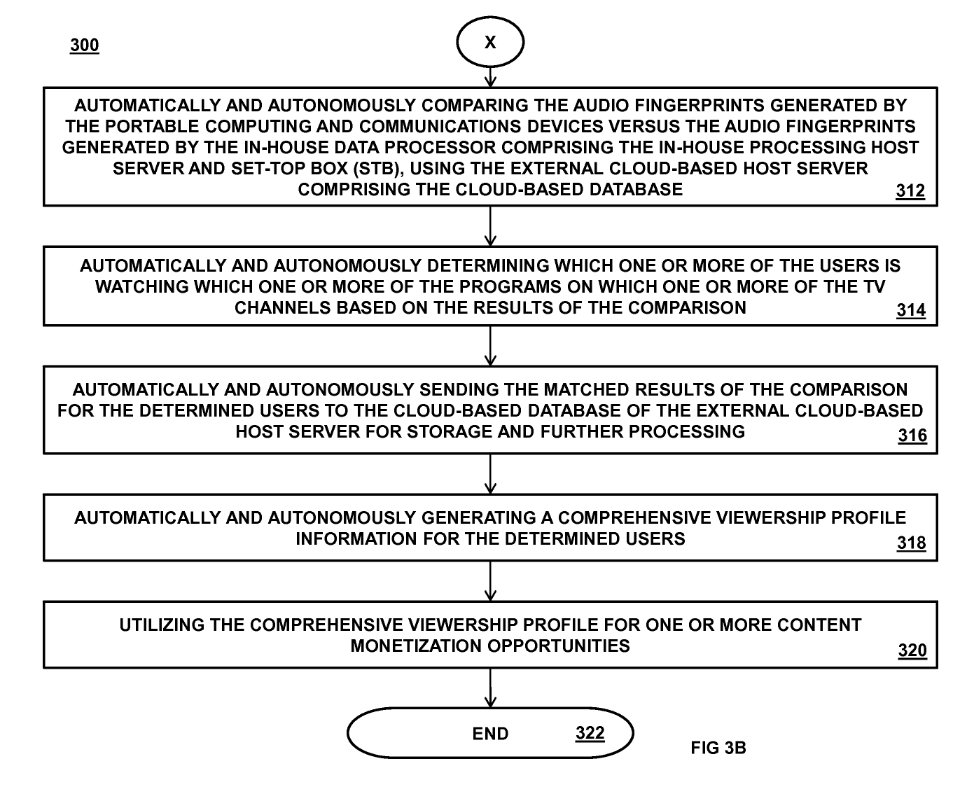

FIGS. 3A-B depict a flow diagram for a method for overall management of TV channel content based on acoustic fingerprinting using portable computing and communications devices, thereby facilitating content identification, content enhancement, audience management, broadcast monitoring and content monetization, according to one or more embodiments.

The method 300 starts at step 302 and proceeds to step 304.

At step 304, the method 300 facilitates, or comprises, automatically and autonomously capturing audio contents at least one of periodically, adaptively, dynamically, randomly, customizably, and via a combination thereof, from programs displayed and viewed on TV channels by users using portable computing and communications devices.

In operation, a TV, for instance the TV 108 of FIG. 1A, provides TV channels for displaying one or more programs and transmitting corresponding audio contents therefrom. Upon transmission of the audio contents, at least one of a first acoustic-to-electric transducer and sensor, for instance the microphone 132 coupled to an I/O unit or port, for instance the first Input/Output (I/O) subunit 118 of a primary screen device, for instance the portable computing and communications device 110, captures the audio data or information in the TV contents. Specifically, the microphone 132, by virtue of design and implementation in accordance with the principles of the present invention, automatically and autonomously captures the audio data or information in the TV contents viewed by the user of the portable computing and communications device 110 at least one of periodically, adaptively, dynamically, randomly, customizably, and a combination thereof.

At step 306, the method 300 facilitates, or comprises, automatically and autonomously generating corresponding audio fingerprints of the captured audio contents using the portable computing and communications devices for transmission to at least one of an external cloud-based host server comprising a cloud-based database. For instance, the external cloud-based host server 146 of the server subsystem 104, of FIG. 1A, comprises the cloud-based database 178. Specifically, the third memory subunit 168 of the third microcomputer unit 164 of the external cloud-based host server 146 comprises the cloud-based database 178.

In operation, a proprietary mobile application software (or mobile app or app), for instance the proprietary mobile app (or acoustic/audio content management application software 138 or acoustic/audio content manager) 138 stored in the first memory subunit 116 of the first microcomputer unit 112 of the portable computing and communications device 110, and installed thereon, facilitates automatic and autonomous generation of corresponding audio fingerprints of the captured audio contents. The proprietary mobile application software 138 is based on a robust acoustic fingerprint algorithm. Specifically, the acoustic fingerprint algorithm takes into consideration the perceptual characteristics of the captured audio signals. For example, and in no way limiting the scope of the invention, the one or more perceptual characteristics often exploited by acoustic or audio fingerprints includes zero crossing rate, estimated tempo, average spectrum, spectral flatness, prominent tones across a set of bands, bandwidth and the like. More specifically, the acoustic/audio fingerprint generator 140 constituting the acoustic/audio content manager 138 facilitates automatic and autonomous generation of corresponding audio fingerprints of the captured audio contents.

At step 306, the method 300 further comprises automatically and autonomously, at least one of periodically, adaptively, dynamically, randomly, customizably, and a combination thereof, varying the sampling interval, specifically the periodicity of the cycle for capturing the audio contents from the programs displayed and viewed on the TV channels by the users using the portable computing and communications devices.

In operation, the acoustic/audio fingerprint generation optimizer 142 constituting the acoustic/audio content manager 138 stored in the first memory subunit 116 of the first microcomputer 112 of the portable computing and communications device 110, and installed thereon, facilitates optimizing generation of acoustic/audio fingerprints, thereby minimizing consumption of the data of the portable computing and communications device 110 and battery therefor. Specifically, the acoustic/audio fingerprint generation optimizer 142 facilitates optimizing the generation of acoustic/audio fingerprints based on managing or maintaining a trade-off between one or more parameters, such as 1) the time consumed, for instance in a task of at least one of customized, adaptive, dynamic, random, and a combination thereof, variation or modification of the sampling interval, specifically the periodicity of the cycle for capturing the audio data in the TV contents viewed by the user of the portable computing and communications device 110, whether particularly in computation or in general response time, 2) the space occupied, for instance the amount of memory consumed in performing the aforementioned task of capturing, whether primary, such as in Random Access Memory (RAM) or secondary, such as on a hard disk drive, of the first memory subunit 116 of the portable computing and communications device 110, 3) the location of the portable computing and communications device 110 used in performing the aforementioned task, 4) the current viewing status of the user, for instance whether or not the user is currently watching the TV, 5) the energy consumed, for instance the amount of battery consumed in performing the aforementioned task, and other battery state management parameters.

At step 308, the method 300 facilitates, or comprises, automatically and autonomously capturing audio contents continuously from all the programs available for display on the TV channels using an in-house data processor comprising at least one of an in-house processing host server and a Set-Top Box (STB).

In operation, a TV, for instance the TV 108 of FIG. 1A, provides TV channels for displaying one or more programs and transmitting corresponding audio contents therefrom. Upon transmission of the audio contents, at least one of an acoustic-to-electric transducer and sensor coupled to an I/O unit or port, for instance the second Input/Output (I/O) subunit 158 of the second microcomputer unit 152 of the in-house processing host server 148 of the in-house data processor 144 of the server subsystem 104, captures the audio data or information in the TV contents. Specifically, the at least one of an acoustic-to-electric transducer and sensor, by virtue of design and implementation in accordance with the principles of the present invention, automatically and autonomously captures audio contents continuously from all the programs available for display on the TV channels using the in-house data processor 144).

At step 310, the method 300 facilitates, or comprises, automatically and autonomously generating corresponding audio fingerprints of the captured audio contents from all the programs available for display on the TV channels using the in-house data processor comprising the in-house processing host server and Set-Top Box (STB) for transmission to the external cloud-based host server comprising the cloud-based database.

In operation, the acoustic/audio fingerprint generator 140 of the acoustic/audio content management application software 138 stored in the second memory subunit 156 of the second microcomputer 152 of the at least one of the in-house processing host servers 148 of the in-house data processor 144, and installed thereon, facilitates automatically and autonomously generating corresponding audio fingerprints of the captured audio contents from all the programs available for display on the TV channels.

At step 312, the method 300 comprises, or facilitates, automatically and autonomously comparing the audio fingerprints generated by the portable computing and communications devices versus the audio fingerprints generated by the in-house data processor comprising the in-house processing host server and Set-Top Box (STB), using the external cloud-based host server comprising the cloud-based database.

In operation, the acoustic/audio fingerprint comparator 176 of the third memory subunit 168 of the third microcomputer unit 164 of the external cloud-based host server 146 facilitates comparing the audio fingerprints generated using the portable computing and communications devices 110 versus the audio fingerprints generated using the in-house data processor 144. Specifically, in operation, the acoustic/audio fingerprint comparator 176 facilitates at least one of randomly, sequentially, customizably, and via a combination thereof, search for one or more matching audio fingerprints generated using the in-house data processor 144 against, or with respect or reference to, one or more audio fingerprints generated using the portable computing and communications devices 110. More specifically, the acoustic/audio fingerprint comparator 176 facilitates accessing the cloud-based database 178 stored in the third memory subunit 168 of the third microcomputer unit 164 of the external cloud-based host server 146 so as to at least one of randomly, sequentially, customizably based on a criteria, for instance based on the audio fingerprints generated using the portable computing and communications devices 110, and a combination thereof, and concurrently scan one or more audio fingerprints generated using the portable computing and communications devices 110 and one or more audio fingerprints generated using the in-house data processor 144, thereby facilitating finding one or more matching audio fingerprints, and retrieving the matched audio fingerprints.

At step 314, the method 300 comprises, or facilitates, automatically and autonomously determining which one or more of the users is watching which one or more of the programs on which one or more of the TV channels based on the results of the comparison.

In operation, the method 300 facilitates detecting or identifying users, identifying the program contents currently being displayed and watched on the TV channels, based on the results of the comparison. In some embodiments, the system 100 facilitates identifying the viewers via capturing one or more unique identifiers associated with, or identifying, the viewers (users) based on one or more portable computing and communications devices used by the viewers, for instance at least one of the International Mobile Subscriber Identity (IMSI), Mobile Equipment Identifier (MEID), International Mobile Station Equipment Identity (IMEI), OS driven IDs associated with portable computing and communications devices, such as ANDROID™ ID and advertiser ID assigned by ANDROID™, Universally Unique Identifier (UDID) and advertising ID assigned by iOS®, and a combination thereof.

At step 316, the method 300 comprises, or facilitates, automatically and autonomously sending the matched results of the comparison for the determined users to the cloud-based database of the external cloud-based host server for storage and further processing.

At step 318, the method 300 comprises, or facilitates, automatically and autonomously generating a comprehensive viewership profile information for the determined users.

At step 320, the method 300 comprises, or facilitates, utilizing the comprehensive viewership profile for one or more content monetization opportunities.

With reference to FIGS. 1A-B, the third memory subunit 168 of each of the external cloud-based host servers 146 comprises a data or an information monetizer application 180. Specifically, the data or information monetizer 180 comprises a TV channel analyzer, disseminator and audience measurer (or measurement application) 182, thereby facilitating analyzing TV channels and comprehensive viewership of TV programs (or program contents) displayed thereupon in connection with the users of the portable computing and communications devices 110. Specifically, in operation, the TV channel analyzer, disseminator and audience measurement application 182 facilitates linking and housing (or storing) data or information from TV channels for analysis to provide business and in particular customer and marketing intelligence, thereby guiding effective and successful decision-making.

Yet again, with reference to FIGS. 1A-B, the data or information monetizer application 180 further comprises a targeted mobile advertisement application 184 for targeted delivery of mobile advertisements based on comprehensive viewership of the users of the portable computing and communications devices 110. For example, and in no way limiting the scope of the invention, targeted mobile advertising is based on various traits of consumers, such as demographics, psychographics, behavioral variables, for instance product, solution or service purchase history, and firmographics, or other second-order activities, which serve as a proxy for the aforementioned traits.

With reference to FIGS. 1A-B, the data or information monetizer application 180 further comprises a targeted in-app engagement application 186 facilitating engagement with at least one of products, solutions and services available for, or for, sale for smartphone users based on comprehensive viewership of the users of the portable computing and communications devices 110.

The embodiments of the present invention may be embodied as methods, system, apparatus, electronic devices, and/or computer program products. Accordingly, the embodiments of the present invention may be embodied in hardware and/or in software (including firmware, resident software, micro-code, etc.), which may be generally referred to herein as a “circuit” or “module”. Furthermore, the present invention may take the form of a computer program product on a computer-usable or computer-readable storage medium having computer-usable or computer-readable program code embodied in the medium for use by or in connection with an instruction execution system. In the context of this document, a computer-usable or computer-readable medium may be any medium that can contain, store, communicate, propagate, or transport the program for use by or in connection with the instruction execution system, apparatus, or device. These computer program instructions may also be stored in a computer-usable or computer-readable memory that may direct a computer or other programmable data processing apparatus to function in a particular manner, such that the instructions stored in the computer-usable or computer-readable memory produce an article of manufacture including instructions that implement the function specified in the flowchart and/or block diagram block or blocks.

The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium include the following: hard disks, optical storage devices, a transmission media such as those supporting the Internet or an intranet, magnetic storage devices, an electrical connection having one or more wires, a portable computer diskette, a Random Access Memory (RAM), a Read-Only Memory (ROM), an Erasable Programmable Read-Only Memory (EPROM or Flash memory), a optical fiber, a compact disc Read-Only Memory (CD-ROM).

Computer program code for carrying out operations of the present invention may be written in object-oriented programming language, such as Java®, Smalltalk or C++, and the like. However, the computer program code for carrying out operations of the present invention may also be written in conventional procedural programming language, such as “C” programming language and/or any other lower level assembler languages. It will be further appreciated that the functionality of any or all of the program modules may also be implemented using discrete hardware components, one or more Application Specific Integrated Circuits (ASICs), or programmed Digital Signal Processors (DSPs) or microcontrollers.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the present disclosure and its practical applications, to hereby enable others skilled in the art to best utilize the invention and various embodiments with various embodiments as may be suited to the particular use contemplated.

### Example Computer System

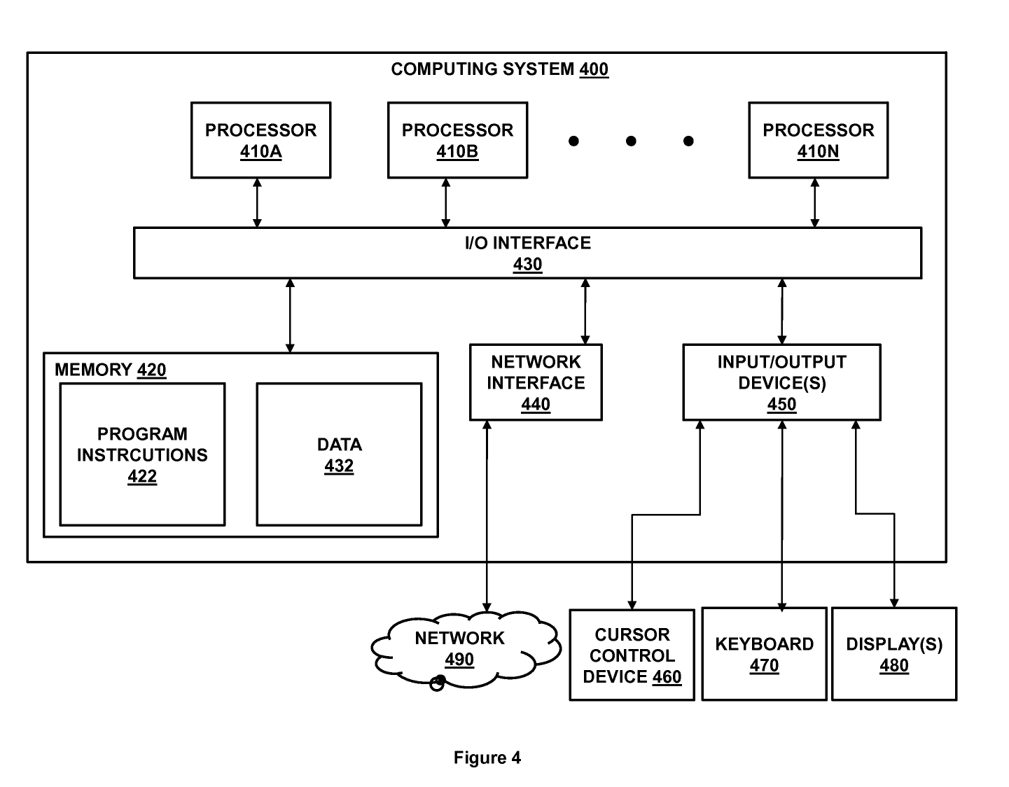

FIG. 4 depicts a computer system that may be a computing device and may be utilized in various embodiments of the present invention.

Various embodiments of the methods and systems for simultaneously wirelessly charging portable devices using custom-designed and retro-designed power control and supply assemblies and architectural structures facilitating hands-free operation of the portable devices and interaction therewith, as described herein, may be executed on one or more computer systems, which may interact with various other devices. One such computer system is computer system 400 illustrated by FIG. 4, which may in various embodiments implement any of the elements or functionality illustrated in FIGS. 1A-B, 2 and 3. In various embodiments, computer system 400 may be configured to implement one or more methods described above. The computer system 400 may be used to implement any other system, device, element, functionality or method of the above-described embodiments. In the illustrated embodiments, computer system 400 may be configured to implement one or more methods as processor-executable executable program instructions 422 (e.g., program instructions executable by processor(s) 410A-N) in various embodiments.

In the illustrated embodiment, computer system 400 includes one or more processors 410A-N coupled to a system memory 420 via an input/output (I/O) interface 430. The computer system 400 further includes a network interface 440 coupled to I/O interface 430, and one or more input/output devices 450, such as cursor control device 460, keyboard 470, and display(s) 480. In various embodiments, any of components may be utilized by the system to receive user input described above. In various embodiments, a user interface (e.g., user interface) may be generated and displayed on display 480. In some cases, it is contemplated that embodiments may be implemented using a single instance of computer system 400, while in other embodiments multiple such systems, or multiple nodes making up computer system 400, may be configured to host different portions or instances of various embodiments. For example, in one embodiment some elements may be implemented via one or more nodes of computer system 400 that are distinct from those nodes implementing other elements. In another example, multiple nodes may implement computer system 400 in a distributed manner.

In different embodiments, computer system 400 may be any of various types of devices, including, but not limited to, a personal computer system, desktop computer, laptop, notebook, or netbook computer, mainframe computer system, handheld computer, workstation, network computer, a camera, a set top box, a mobile device, a consumer device, video game console, handheld video game device, application server, storage device, a peripheral device such as a switch, modem, router, or in general any type of computing or electronic device.

In various embodiments, computer system 400 may be a uniprocessor system including one processor 410, or a multiprocessor system including several processors 410 (e.g., two, four, eight, or another suitable number). Processors 410A-N may be any suitable processor capable of executing instructions. For example, in various embodiments processors 410 may be general-purpose or embedded processors implementing any of a variety of instruction set architectures (ISAs), such as the x96, POWERPC®, SPARC®, or MIPS® ISAs, or any other suitable ISA. In multiprocessor systems, each of processors 410A-N may commonly, but not necessarily, implement the same ISA.

System memory 420 may be configured to store program instructions 422 and/or data 432 accessible by processor 410. In various embodiments, system memory 420 may be implemented using any suitable memory technology, such as static random access memory (SRAM), synchronous dynamic RAM (SDRAM), nonvolatile/Flash-type memory, or any other type of memory. In the illustrated embodiment, program instructions and data implementing any of the elements of the embodiments described above may be stored within system memory 420. In other embodiments, program instructions and/or data may be received, sent or stored upon different types of computer-accessible media or on similar media separate from system memory 420 or computer system 400.

In one embodiment, I/O interface 430 may be configured to coordinate I/O traffic between processor 410, system memory 420, and any peripheral devices in the device, including network interface 440 or other peripheral interfaces, such as input/output devices 450. In some embodiments, I/O interface 430 may perform any necessary protocol, timing or other data transformations to convert data signals from one components (e.g., system memory 420) into a format suitable for use by another component (e.g., processor 410). In some embodiments, I/O interface 430 may include support for devices attached through various types of peripheral buses, such as a variant of the Peripheral Component Interconnect (PCI) bus standard or the Universal Serial Bus (USB) standard, for example. In some embodiments, the function of I/O interface 430 may be split into two or more separate components, such as a north bridge and a south bridge, for example. Also, in some embodiments some or all of the functionality of I/O interface 430, such as an interface to system memory 420, may be incorporated directly into processor 410.

Network interface 440 may be configured to allow data to be exchanged between computer system 400 and other devices attached to a network (e.g., network 490), such as one or more external systems or between nodes of computer system 400. In various embodiments, network 490 may include one or more networks including but not limited to Local Area Networks (LANs) (e.g., an Ethernet or corporate network), Wide Area Networks (WANs) (e.g., the Internet), wireless data networks, some other electronic data network, or some combination thereof. In various embodiments, network interface 440 may support communication via wired or wireless general data networks, such as any suitable type of Ethernet network, for example; via telecommunications/telephony networks such as analog voice networks or digital fiber communications networks; via storage area networks such as Fiber Channel SANs, or via any other suitable type of network and/or protocol.

Input/output devices 450 may, in some embodiments, include one or more display terminals, keyboards, keypads, touchpads, scanning devices, voice or optical recognition devices, or any other devices suitable for entering or accessing data by one or more computer systems 400. Multiple input/output devices 450 may be present in computer system 400 or may be distributed on various nodes of computer system 400. In some embodiments, similar input/output devices may be separate from computer system 400 and may interact with one or more nodes of computer system 400 through a wired or wireless connection, such as over network interface 440.

Those skilled in the art will appreciate that computer system 400 is merely illustrative and is not intended to limit the scope of embodiments. In particular, the computer system and devices may include any combination of hardware or software that can perform the indicated functions of various embodiments, including computers, network devices, Internet appliances, PDAs, wireless phones, pagers, etc. Computer system 400 may also be connected to other devices that are not illustrated, or instead may operate as a stand-alone system. In addition, the functionality provided by the illustrated components may in some embodiments be combined in fewer components or distributed in additional components. Similarly, in some embodiments, the functionality of some of the illustrated components may not be provided and/or other additional functionality may be available.

Those skilled in the art will also appreciate that, while various items are illustrated as being stored in memory or on storage while being used, these items or portions of them may be transferred between memory and other storage devices for purposes of memory management and data integrity. Alternatively, in other embodiments some or all of the software components may execute in memory on another device and communicate with the illustrated computer system via inter-computer communication. Some or all of the system components or data structures may also be stored (e.g., as instructions or structured data) on a computer-accessible medium or a portable article to be read by an appropriate drive, various examples of which are described above. In some embodiments, instructions stored on a computer-accessible medium separate from computer system 400 may be transmitted to computer system 400 via transmission media or signals such as electrical, electromagnetic, or digital signals, conveyed via a communication medium such as a network and/or a wireless link. Various embodiments may further include receiving, sending or storing instructions and/or data implemented in accordance with the foregoing description upon a computer-accessible medium or via a communication medium. In general, a computer-accessible medium may include a storage medium or memory medium such as magnetic or optical media, e.g., disk or DVD/CD-ROM, volatile or non-volatile media such as RAM (e.g., SDRAM, DDR, RDRAM, SRAM, etc.), ROM, etc.

The methods described herein may be implemented in software, hardware, or a combination thereof, in different embodiments. In addition, the order of methods may be changed, and various elements may be added, reordered, combined, omitted, modified, etc. All examples described herein are presented in a non-limiting manner. Various modifications and changes may be made as would be obvious to a person skilled in the art having benefit of this disclosure. Realizations in accordance with embodiments have been described in the context of particular embodiments. These embodiments are meant to be illustrative and not limiting. Many variations, modifications, additions, and improvements are possible. Accordingly, plural instances may be provided for components described herein as a single instance. Boundaries between various components, operations and data stores are somewhat arbitrary, and particular operations are illustrated in the context of specific illustrative configurations. Other allocations of functionality are envisioned and may fall within the scope of claims that follow. Finally, structures and functionality presented as discrete components in the example configurations may be implemented as a combined structure or component. These and other variations, modifications, additions, and improvements may fall within the scope of embodiments as defined in the claims that follow.

While the foregoing is directed to embodiments of the present invention, other and further embodiments of the invention may be devised without departing from the basic scope thereof, and the scope thereof is determined by the claims that follow.

1. A method for media content management and monetization, the method comprising:
automatically and autonomously capturing audio contents at least one of periodically, adaptively, dynamically, randomly, customizably, and via a combination thereof, from programs displayed and viewed on TV channels by users using portable computing and communications devices;
automatically and autonomously generating corresponding audio fingerprints of the captured audio contents using the portable computing and communications devices for transmission to at least one of an external cloud-based host server comprising a cloud-based database;
automatically and autonomously capturing audio contents continuously from all the programs available for display on the TV channels using an in-house data processor comprising at least one of an in-house processing host server and a Set-Top Box (STB);
automatically and autonomously generating corresponding audio fingerprints of the captured audio contents from all the programs available for display on the TV channels using the in-house data processor comprising the in-house processing host server and Set-Top Box (STB) for transmission to the external cloud-based host server comprising the cloud-based database;
automatically and autonomously comparing the audio fingerprints generated by the portable computing and communications devices versus the audio fingerprints generated by the in-house data processor comprising the in-house processing host server and Set-Top Box (STB), using the external cloud-based host server comprising the cloud-based database;
automatically and autonomously determining which one or more of the users is watching which one or more of the programs on which one or more of the TV channels based on the results of the comparison;
automatically and autonomously sending the matched results of the comparison for the determined users to the cloud-based database of the external cloud-based host server for storage and further processing;
automatically and autonomously generating a comprehensive viewership profile information for the determined users; and
utilizing the comprehensive viewership profile for one or more content monetization opportunities.

2. The method of claim 1, wherein the media content comprises a primary content displayable on the TV and a second screen content displayable on a second screen device.

3. The method of claim 1, wherein the automatic and autonomous capture of the audio contents and generation of the corresponding audio fingerprints of the captured audio contents is optimized using an acoustic/audio fingerprint generation optimizer, thereby facilitating minimizing consumption of one or more general resources of the portable computing and communications devices.

4. The method of claim 3, wherein the general resources subject to consumption are at least one of space, time and energy in connection with the portable computing and communications devices, and the audio content acquisition, audio fingerprint generation and optimization algorithms implemented thereby.

5. The method of claim 4, wherein the space refers to the amount of the memory subunit of the portable computing and communications devices consumed, whereas the time refers to the time consumed, and wherein the energy refers to the battery consumed in performance of the steps of automatically and autonomously capturing the audio contents at least one of periodically, adaptively, dynamically, randomly, customizably, and via the combination thereof, from the programs displayed and viewed on TV channels by users using the portable computing and communications devices and automatically and autonomously generating corresponding audio fingerprints of the captured audio contents using the portable computing and communications devices.

6. The method of claim 1, wherein the step of automatically and autonomously capturing audio contents at least one of periodically, adaptively, dynamically, randomly, customizably, and via the combination thereof, from the programs displayed and viewed on the TV channels by the users using the portable computing and communications devices further comprises:
automatically and autonomously, at least one of periodically, adaptively, dynamically, randomly, customizably, and via a combination thereof, varying the sampling interval, specifically the periodicity of the cycle for capturing the audio contents from the programs displayed and viewed on the TV channels by the users using the portable computing and communications devices.

7. The method of 3, wherein the automatic and autonomous capture of the audio contents and generation of the corresponding audio fingerprints of the captured audio contents is optimized via managing a trade-off between at least one of the space, time, energy, and a combination thereof, consumed therein comprising automatically and autonomously, at least one of periodically, adaptively, dynamically, randomly, customizably, and via the combination thereof, varying the sampling interval, specifically the periodicity of the cycle for capturing the audio contents, using the acoustic/audio fingerprint generation optimizer, thereby facilitating minimizing consumption of one or more general resources of the portable computing and communications devices.

8. A method for second screen real-time engagement comprising:
at least one of inputting and transmitting a plurality of second screen information items comprising one or more input audio fingerprints, second screen engagement contents and formats therefor, from one or more external content sources to an external cloud-based host server comprising a cloud-based database;
automatically and autonomously generating corresponding audio fingerprints of the captured audio contents from all the programs available for display on the TV channels using an in-house data processor comprising one or more in-house processing host servers and Set-Top Boxes (STBs) for transmission to the external cloud-based host server comprising the cloud-based database;
automatically and autonomously comparing the at least one of inputted and transmitted plurality of second screen information items comprising the one or more input audio fingerprints versus the audio fingerprints of the captured audio contents from all the programs available for display on the TV channels;
upon finding one or more matches, transmitting the instantly matched input audio fingerprints corresponding to one or more given TV channels to the portable computing and communications devices whose users are currently watching the TV to confirm whether the users are watching the matched TV channels;
upon confirmation, transmitting the audio fingerprints of the matched TV channels, second screen engagement contents and formats therefor to the portable computing and communications devices;
upon reception of the matched TV channels, at least one of periodically, adaptively, dynamically, customizably, and via a combination thereof, automatically capturing audio content from a program currently displayed on the TV channel using the portable computing and communications devices;
automatically and autonomously generating corresponding audio fingerprint of the captured audio content from the program currently displayed on the TV channel; and
upon matching of the audio fingerprint of the at least one of the incoming and received audio fingerprint content from the captured audio fingerprint of the program currently displayed and watched on the TV channel, displaying the second screen content on the portable computing and communications device based on the second screen engagement content, in accordance with the format therefor.

9. A system for media content management and monetization, the method comprising:
a client subsystem comprising:
one or more portable computing and communications devices comprising:
a first microcomputer unit comprising:
a first Input/Output (I/O) subunit coupled to at least one of a first acoustic transducer and sensor facilitating automatically and autonomously capturing audio contents at least one of periodically, adaptively, dynamically, randomly, customizably, and via a combination thereof, from programs displayed and viewed on TV channels by users, and
a first memory subunit comprising:
a client-side proprietary mobile application software comprising:
an acoustic/audio fingerprint generator facilitating automatically and autonomously generating corresponding audio fingerprints of the captured audio contents using the portable computing and communications devices; and
a server subsystem comprising:
an in-house data processor comprising:
at least one of a second acoustic transducer and sensor facilitating automatically and autonomously capturing audio contents continuously from all the programs available for display on the TV channels, and
an in-house processing host server comprising:
a second microcomputer unit comprising:
a second memory subunit comprising:
a server-side proprietary mobile application software comprising:
the acoustic/audio fingerprint generator facilitating automatically and autonomously generating corresponding audio fingerprints of the captured audio contents from all the programs available for display on the TV channels;
an external cloud-based host server comprising:
a third microcomputer unit comprising:
a third memory subunit comprising:
a cloud-based database and an acoustic/audio fingerprint comparator facilitating automatically and autonomously comparing the audio fingerprints generated by the portable computing and communications devices versus the audio fingerprints generated by the in-house data processor comprising the in-house processing host server, wherein the external cloud-based host server facilitates automatically and autonomously determining which one or more of the users is watching which one or more of the programs on which one or more of the TV channels based on the results of the comparison, and wherein the external cloud-based host server facilitates automatically and autonomously sending the matched results of the comparison for the determined users to the cloud-based database of for storage and further processing, and wherein the external cloud-based host server facilitates automatically and autonomously generating a comprehensive viewership profile information for the determined users, and wherein the external cloud-based host server facilitates utilizing the comprehensive viewership profile for one or more content monetization opportunities.
